(19) United States
(12) Patent Application Publication
(10) Pub. No.: US 2021/0298513 A1
(43) Pub. Date: Sep. 30, 2021

(54) Steam Enhanced Roaster

(71) Applicant: Magellan Home-Goods, Ltd., Blaine, WA (US)

(72) Inventors: Andre Dean Cloutier, Blaine, WA (US); Debra Lynne Sasken-Duff, Custer, WA (US)

(21) Appl. No.: 17/211,668

(22) Filed: Mar. 24, 2021

Related U.S. Application Data
(60) Provisional application No. 63/000,258, filed on Mar. 26, 2020.

(51) Int. Cl. A47J 27/04; A47J 37/10

(52) U.S. Cl. CPC A47J 27/04; A47J 2027/043; A47J 37/108

(57) ABSTRACT

A cooking utensil is disclosed herein, in one example comprising: a cooking pan having a base panel with a perimeter sidewall extending thereabove around the circumference thereof so as to contain a volume of fluid in the cooking pan; a steamer pan positioned within the cooking pan above the base panel. A steamer dome attached to the steamer pan and extending vertically upwards therefrom. The steamer dome configured to extend into a food item to be cooked with a substantially non-permeable top cap so as to direct vapors from fluids heated within the cooking pan through the central void of the steamer insert plate and laterally through the side wall into the food item to be cooked.

### RELATED APPLICATIONS

This application claims priority of U.S. Provisional Patent Application Ser. No. 63/000,258 filed on Mar. 26, 2020 incorporated herein by reference.

### BACKGROUND OF THE DISCLOSURE

### Field of the Disclosure

This disclosure relates to the field of cooking devices and, more particularly, relates to a cooking (roasting) device for holding a selected food item, in one example poultry, to facilitate the roasting, steaming, and flavoring of the food item with the vapors (steam etc.) from heated fluids including fluids from the food item injected into a cavity within the food item as the food item is cooked.

### BRIEF SUMMARY OF THE DISCLOSURE

A cooking steam enhanced roaster is disclosed herein. The steam enhanced roaster in one example comprising: a cooking pan having a base panel with a perimeter sidewall extending thereabove around the circumference thereof so as to contain a first volume of fluid in the cooking pan; a steamer dome removably fitted to the cooking pan above the base panel, a steamer pan attached to the cooking pan directly below the steamer dome and configured to hold a second volume of fluid. The steamer dome in one example is removably attached to the cooking pan overlying the steamer pan and extending vertically upwards therefrom. The steamer dome configured to extend vertically upwards into a cavity within the food item to be cooked. The steamer dome of one example having a laterally permeable perimeter wall extending vertically upwards from the cooking to a substantially non-permeable top cap so as to direct steam and vapors from fluids heated within the steamer pan laterally through the side wall into the cavity of the food item to be cooked.

The cooking utensil may be arranged wherein the top cap portion of the steamer dome is substantially non-porous, non-permeated.

The cooking utensil may be arranged wherein the steamer pan comprises a horizontally extending attachment protrusion which is bayonet fit to an inner surface of the steamer dome to hold the steamer dome in position on the cooking pan.

### BRIEF DESCRIPTION OF THE SEVERAL VIEWS OF THE DRAWINGS

FIG. 1 is a top/front isometric view of one example of the steam enhanced roaster as disclosed herein, assembled.

FIG. 2 is a top/front isometric hidden line view of another example of the steam enhanced roaster as disclosed herein, partially assembled.

FIG. 3 is a side cutaway view of a steamer dome component shown in FIG. 1 for a first/large food item.

FIG. 4 is a side cutaway view of a steamer dome component shown in FIG. 1 for a second/small food item.

FIG. 5 is a side view of a bowl insert component.

FIG. 6 is a side cutaway view of a cooking pan component shown in FIG. 1.

FIG. 7 is a side hidden line view of the assembled apparatus of FIG. 2 in use.

FIG. 8 top view of the apparatus shown in FIG. 1.

FIG. 9 is an assembled perspective view of the apparatus shown in FIG. 1.

FIG. 10 is a side view of the apparatus shown in FIG. 1, the opposing side view being a mirror image thereof.

FIG. 11 is a front view of the apparatus shown in FIG. 1, the opposing view being a mirror image thereof.

FIG. 12 is a bottom view of the apparatus shown in FIG. 1, the opposing view being a mirror image thereof.

FIG. 13 is a side cross-sectional view of one example of a steamer dome component of the apparatus shown in FIG. 1.

### DETAILED DESCRIPTION OF THE DISCLOSURE

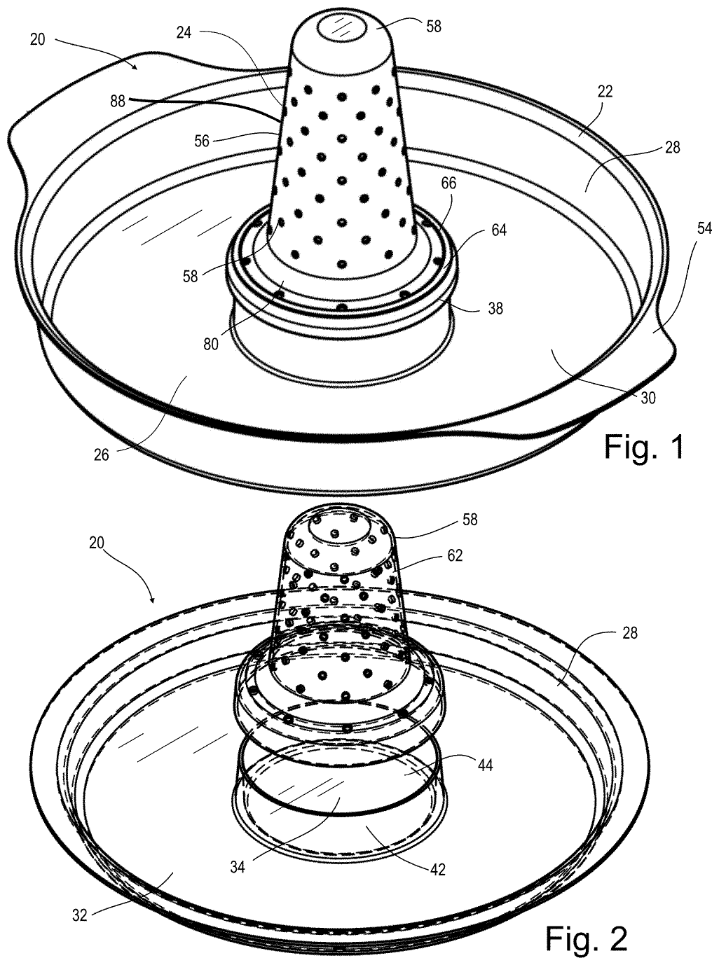

Disclosed herein is a steam enhanced roaster 20 as shown in one example in FIG. 1 for use in cooking of food items. In particular, the steam enhanced roaster 20 is particularly useful for the cooking of meats such as chicken, turkey, game hens, duck, goose, etc. The steam enhanced roaster 20 also useful for the cooking of plant-based food items such as pumpkin, squash, etc.

In the cooking of food items, particularly turkey, chicken, game hens, and other poultry, the desired cooking time and flavoring to penetrate the meat from the inside to the outside in order to impart moisture, flavor, and tenderness to the meat. It is common when cooking such foods, in particular large food items such as turkeys, to overcook the outer portions of the food item in an attempt to completely cook the interior portion. To flavor and properly cook the food, various techniques have been employed, including stuffing an inner cavity of the food item with various vegetables, stuffing, rice, and flavorings. However, these methods suffer from several disadvantages including non-uniform application of heat to the outside of the food item. This is typically the result as heat is applied by using an oven or similar appliance. In such examples, as heat is applied to the outside of the food item, the heat often overcooks the outside layer of the food item and often undercooks the inside of the food item as the heat does not permeate the food item well. To achieve correct heat permeation, often the food item is cooked for extended time. Other known solutions include the use of a drip pan with an upward-standing can or similar device of sufficient size and shape to extend into the cavity of a turkey, chicken, or other food item and facilitate the introduction of vapors from the drip pan. Many of these devices are used for collecting the drippings which may include fat and other liquids from the food item into the drip pan, without allowing the drippings to fall on the heating elements of the oven, BBQ, etc.

Supports and stands are well-known in the art for supporting food items in an oven while the food item is being cooked. These supports and stands each suffer from specific detriments, these detriments being alleviated in the examples shown herein.

Looking to FIG. 1 is shown one example of the steam enhanced roaster 20 fully assembled. The steam enhanced roaster 20 of this example comprises several components. These individual components may be separated without tools and without damage to each other. This separation of these components useful for ease in cleaning, shipping, interchanging components for various uses, and storage of the roaster 20. One example, FIG. 1 shows the steam enhanced roaster 20 comprising several sub-components including: a cooking pan 22 and a removable steamer dome 24. Each of the cooking pan 22 and steamer dome 24 may be made of rigid materials such as aluminum, bakelite, cast iron, ceramic, glass, stainless steel, and other rigid or semi-rigid components. The steamer dome 24 generally attached to the cooking pan 22 and projecting vertically a cooking reservoir 26 portion of the cooking pan 22.

In this example, the cooking pan 22 comprises a cooking (fluid) reservoir 26 comprised of a perimeter sidewall 28 encircling a base panel 30 and commonly sealed thereto. The perimeter sidewall 28 encircling the base panel 30 configured that the cooking reservoir 26 of one example will retain fluids therein. The cooking pan 22 thus arranged may retain solid and fluid residuals 34 from the food item 36.

During cooking, it may be desired to impart steam into the item to be cooked to improve the quality of the cooked food item, and to increase cooking efficiency. To accomplish this, a use can place a small volume of water or other steam liquid 34 into a steamer pan 38 portion of the steam enhanced roaster 20 prior to cooking of the food item 36. As the steam enhanced roaster 20, steam liquid, and food item 36, are heated in an oven 38, on a grill, on or in a barbeque, or similar heating region, the steam fluid 34 which may be water, stock juices, spices, pan juices, or other liquids and combinations thereof from the item to be cooked or other sources heat and turn into vapor (steam) 40 which is then utilized in the cooking process. In one example, the steamer pan 38 is differentiated (separated/fluid isolated) from the cooking reservoir 26 by way of a steamer pan sidewall 42 extending vertically from the base panel 30. The steamer pan sidewall 42 of this example being radially inward from the perimeter sidewall 28. The steamer pan sidewall 42 thus defining a steamer pan reservoir 44 which in one example is fluidly separate from the cooking reservoir 26.

In one example the steamer dome 24 removably attaches to the steamer pan sidewall 42 via a latching mechanism 46 such as a threaded connection, bayonet connection, press fit, securing tabs, or quarter turn attachment. In some applications with a substantially high steamer dome 24 and heavy or tall food item 36, the weight of the food item 36 may topple the steamer dome 24 off of the cooking pan 22. This is especially true when cooking larger (taller) food items such as turkeys or geese.

In one example, the latching mechanism 46 comprises a bayonet or quarter-turn attachment. For example, a radially outward extending protrusion 48 on the steamer pan sidewall 42 engages a radially inward extending protrusion 50 on the lower edge 52 of the steamer dome 24. Each of these protrusions engage the other in a bayonet or quarter-turn attachment. alternatively, the steamer dome 24 and steamer pan 38 may be connected by way of threads on each surface, adhesives, welding, pins, rivets, hook and eye catch, protrusion/indent, recessed ball catch, and other structures and methods.

For ease in lifting the roaster 20 along with any food item 36 and fluids, the perimeter sidewall 28 may comprise a radially outward protrusion 54 or equivalent structure extending horizontally away from the center or inner portion (e.g. steamer pan 38) of the cooking pan 22. This protrusion 54 extends radially outward to form a handle for lifting the steam enhanced roaster 20, food item. This protrusion 54 may extend circumferentially around the cooking pan as shown in FIG. 2 or may only extend a portion of the circumference as shown in FIG. 1.

The steamer dome 24 of this example may include a food engagement surface 56 facing radially outward. This food engagement surface 56 may be frusta-conic wherein the base cone is formed by a set of straight lines connecting a common point, the apex 74, to all of the points on a base that is in a plane that does not contain the apex. Other cones using curved lines, resulting in a curved outer surface are also known in some uses, but in some examples fail to support a larger food item 36 from twisting about the steamer dome 24 and falling off of the steamer dome 24.

This food engagement surface 56 shown in FIG. 13 comprises surfaces defining steam injection holes 58 through which steam 40 exits the steam chamber 62 to the food item 36. The steam chamber disclosed herein defined by the inner surfaces of the steamer dome 24 and steamer pan 38. In one example, the only conduits through the steam chamber 62 are in direct contact with the food item 36. For example, the steam injection holes 58, are on the surface in direct contact with the food item, result in relatively high-pressure steam exiting the steam chamber 62 and directly contacting the food item 36 thus imparting heat and fluid to the food item 36. Often, as the food item 36 using previously known cooking methods, heating from only the exterior, the cooking time was known to be long and dry, thus basting was often required and still the food item dried out especially from the interior thereof. This resulting in a less than savory experience. Many methods and devices have been conceived in an attempt to produce a moist, fully cooked food item in a relatively short time span, including injecting the food item with liquid, and deep fat frying. None of the known methods and devices resulting in the desired balance of cook time, exterior and interior cooked condition, cook time, and ease of preparation.

To increase efficiency, the connection between the steamer dome 24 and cooking pan 22 may be sealed, partially sealed, or substantially sealed to reduce steam and vapors from passing this connection, thus forcing the vapors through the holes 58.

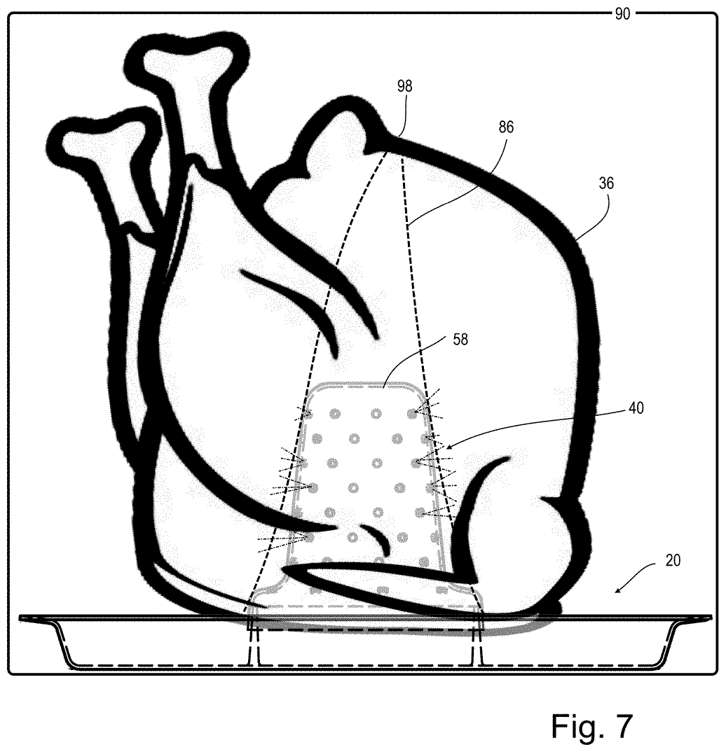

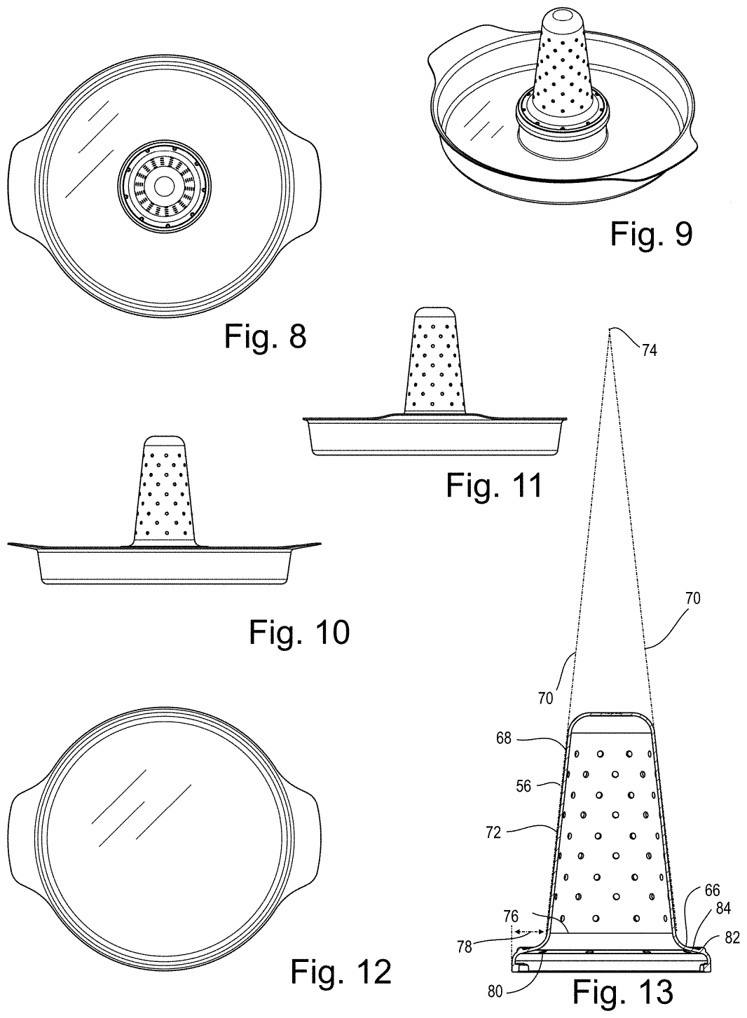

As the upper end 98 of an inner cavity 86 of many food items 36 is open as shown in FIG. 7, it may be desired that the top 58 of the steamer dome 24 be non-permeable/non-perforated. Thus, steam, vapors, hot gases, etc. from the steam fluid 34 heated in the steamer pan 38 will rise through convection within the steamer dome 24 and create positive pressure in the steam chamber 62 upward into the steamer dome 24. This pressure thus forcing the vapors/steam 40 and laterally through the steam injection holes 8 into the food item 36. The combination of convection and/or radiant heat from the oven on the exterior surface of the food item 36 with steam 40 injection on the inner surface defining a cavity in the food item 36 more efficiently cooks the food item 36.

In one example shown in FIG. 13, the lower region of the steamer dome 24 comprises a dome base 64 having a larger horizontal diameter than the food engagement surface 56 thus forming a radially projecting step 66. Where the food engagement surface 56 comprises a frusta-cone 68 wherein the base cone 72 is formed by a set of straight lines 70 connecting a common point, the apex 74, to all of the points on a base 76 that is in a plane that does not contain the apex 74. In one example, the base 76 is a circle.

The step 66 of this example projects horizontally/radially outward from the frusta cone 68 and a geometric projection thereof a distance 78. The step 66 projecting radially away from the frusta cone 68 to form a step which will collect at least some condensate/liquid/drippings flowing by gravity down the food engagement surface 56 of the steamer dome 24. In one example, surfaces defining fluid return holes 80 are provided in the step 66 vertically above the steamer pan 38 so that these returned liquids and food particulates flow through the return holes 80 of the step 66 of the steamer dome 24 into the steamer pan 38. In the steamer pan 38 these liquids add to the volume of the steam liquid 34 where they are heated and again generate steam to cook the food item 36.

In one example, most easily seen in FIG. 13, the step 66 is a substantially shallower vertical slope than the food engagement surface 56, thus giving the returning fluids longer time on the step 66. This arrangement increasing the volume that flows through the return holes 80 into the steamer pan 38.

FIG. 13 also shows a circumferential detent 82 on the step 66 vertically above and/or radially outward of the return holes 80. This detent 82 or ridge forming a trough 84 at the return holes 80 or reservoir on the step 66 to retain return fluids on the step 66 to increase the volume of return fluids flowing through the return holes 80 into the steamer pan 38.

As previously mentioned, in one example, the top 58 of the steamer dome 24 is not perforated so as to maximize steam 40 toward the food item 36. Whereas many food items, such as chickens, turkeys and other foul are open on the upper and lower ends, steam 40 exiting through the top 58 of the steamer dome 24 may exit the food item 36 while not heating the food item 36. Thus, in one example the top 58 of the steamer dome 58 is substantially non-porous, substantially not perforated. This arrangement will maximize steam flow through the steam injection holes 58.

In one example, during cooking the steamer dome 24 may be inserted into the food item 36 prior to attachment to the cooking pan 22 to aid in assembly of these components. For example, the cooking pan 22 with steamer dome 24 installed thereon with the steam fluid 34 previously in place in the steamer pan 38 may be inserted into an oven or similar heated chamber once combined. Thereafter, the food item 36 and steamer dome 28 may be attached to the cooking pan 22, thus diving the weight of the component combinations to be moved at one time. While such as not required commonly for small food items such as chickens, squash, and ducks for example, larger food items such as geese or turkeys may be aided by such component installation as the entire assembled weight cooking pan 22, steamer dome 24, steam liquid 34, and food item 36, need not be moved at the same time but may be moved in and out of the oven 88 as sub-assemblies.

In one example, the steamer dome 24 comprises a perimeter wall or food engagement surface 56 which frictionally engages the inner walls of the cavity 86 of the food item 36. To facilitate steam ejection through the steamer dome 24 the perimeter sidewall 88 may be laterally permeated by way of a surfaces defining laterally extending vents or stem injection holes 58 through the sidewall structure 88.

Testing has shown that cook time is harder significantly enhanced by the efficiency provided by this combination of components. For example, placing a 5 pound chicken in a pan and placing this in a preheated oven at 425° cooking time to achieve a safe internal temperature for cooked chicken at 165° F. took one hour and 20 min. Cooking an equivalent 5 pound chicken with the cooking utensil 20 disclosed herein in a preheated oven at 425° took 24 min. to achieve the same safe internal temperature of the hundred and 65° F.

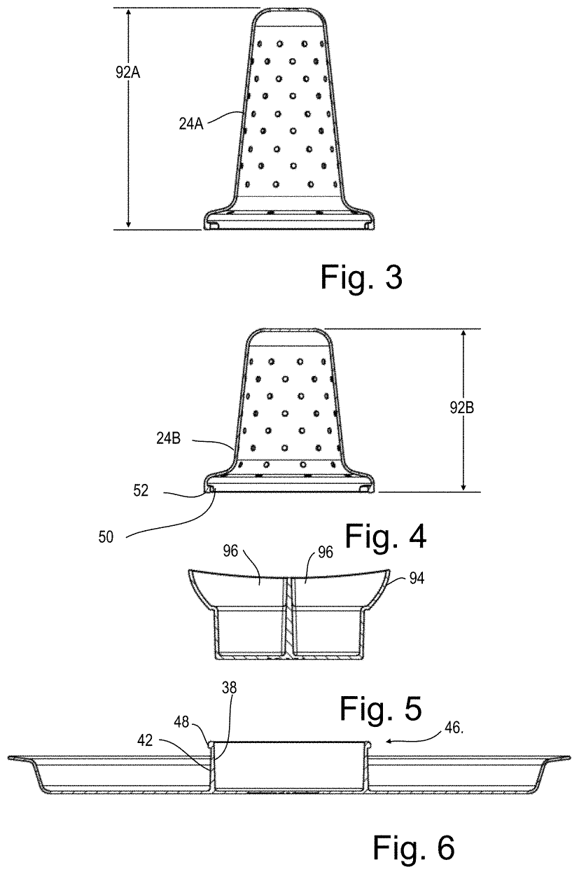

FIG. 3 showing a steamer dome 24A having a first height 92A for food items of relatively large size such as geese, pumpkins, turkeys.

FIG. 4 showing a steamer dome 24B having a second height 92B for food items of relatively small size such as chickens, hens, and squash.

Either of these may be combined with the cooking pan 22 shown in FIG. 1 or in FIG. 2.

Also shown is a dip bowl 94 configured to attach to the steamer pan 38. This allowing for the containing of dips when the device 20 is used as a snack tray. For example, the cooking pan 22 may be used to serve corn chips while dips or sauces are placed in receiving reservoirs 96. In one example, the dip bowl is a malleable material such as silicone and thus easy to clean and less likely to damage corn chips and the like during dipping.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

1. A cooking utensil comprising:
a cooking pan having a base panel with a perimeter sidewall extending thereabove around the circumference thereof so as to contain a volume of fluid in the cooking pan;
a steamer pan positioned within the cooking pan;
the steamer insert pan comprising a steamer pan sidewall radially inward of a perimeter sidewall of the cooking pan;
a steamer dome removably attached to the steamer pan overlying the steamer pan and extending vertically upwards therefrom, the steamer dome configured to extend vertically upwards into a food item to be cooked;
the steamer dome comprising a base having a radially extending step thereof configured to capture fluids draining own the food engagement surface and transfer them to the steamer pan; and
the steamer dome having a laterally permeable perimeter wall extending vertically upwards from the steamer pan to a substantially non-permeable top cap so as to direct vapors from fluids heated within the steamer pan through the central void of the steamer insert plate and laterally through the side wall into the food item to be cooked.

2. A cooking utensil comprising:
a cooking pan having a base panel with a perimeter sidewall extending thereabove around the circumference thereof so as to contain a volume of fluid in the cooking pan;
a steamer pan within the cooking pan;
the steamer insert pan comprising a steamer pan sidewall radially inward of a perimeter sidewall of the cooking pan;
a steamer dome removably attached to the steamer pan sidewall overlying the steamer pan and extending vertically upwards therefrom, the steamer dome configured to extend vertically upwards into a food item to be cooked;

3. The cooking utensil as recited in claim 2, the steamer dome comprising:
a base having a radially extending step thereof configured to capture fluids draining own the food engagement surface and transfer these fluids to the steamer pan.

4. The cooking utensil as recited in claim 2, the steamer dome comprising:
a laterally permeable perimeter wall extending vertically upwards from the steamer pan to a substantially non-permeable top cap so as to direct vapors from fluids heated within the steamer pan through the central void of the steamer insert plate and laterally through the side wall into the food item to be cooked.

5. The cooking utensil as recited in claim 2, comprising:
a dip bowl configured to removably attach to the steamer pan.

6. The cooking utensil as recited in claim 5, the dip bowl comprising a malleable material.

7. The cooking utensil as recited in claim 2, comprising:
a first steamer dome having a first height for food items of relatively large size such as geese, pumpkins, turkeys; and
a second steamer dome having a second height for food items of relatively small size such as chickens, hens, and squash.
